(19) United States
(12) Patent Application Publication
(10) Pub. No.: US 2012/0138044 A1
(43) Pub. Date: Jun. 7, 2012

(54) GAS VENT PIPE AND LOCKING SYSTEM

(75) Inventor: Eric Brunette, Boisbriand (CA)

(73) Assignee: Lennox Hearth Products LLC, Nashville, TN (US)

(21) Appl. No.: 13/172,334

(22) Filed: Jun. 29, 2011

Related U.S. Application Data
(60) Provisional application No. 61/420,610, filed on Dec. 7, 2010.

(51) Int. Cl. F23J 13/04; B23P 17/00; F16L 39/00

(52) U.S. Cl. 126/312; 285/317; 29/428

(57) ABSTRACT

One aspect provides a vent pipe section that comprises a body member having first and second ends and a central axis along a length thereof, a latch receiving member protruding from a side surface of and coupled to the body member and located adjacent one of the first or second ends, a movable latch attached to the body member and located adjacent an end opposite to that of the latch receiving member and configured to cooperatively engage the latch receiving member and exert a locking force along the central axis of the body member. This embodiment further includes a stop located on an outer surface of the body member adjacent the second end. A method of manufacture is also provided.

### CROSS-REFERENCE TO RELATED APPLICATION

This application claims the benefit of U.S. Provisional Application Ser. No. 61/420,610, filed by Eric Brunette on Dec. 7, 2010, entitled “SPECIAL GAS VENT CHIMNEY LOCKING AND SEALING SYSTEM,” commonly assigned with this application and incorporated herein by reference.

### TECHNICAL FIELD

This application is directed, in general, to a vent pipe for a heating appliance and, more specifically, to a vent pipe that has an improved sealing and locking system associated therewith.

### BACKGROUND

Home heating appliances, such as gas furnaces or hot water heaters, are extensively used in residences and business and governmental regulations often require that these furnaces be adequately ventilated to the outside of the structure, such as a commercial building or residence. As such, vent pipes are assembled to extend from the appliances to an opening in the roof or wall of the structure that vents to the outside. In some instances, this distance can be several feet, and in such cases, a number of sections are typically assembled to span this distance. Typically, the joined vent pipes lack structural support, even when banded together. Additionally, as the vent pipe heats due to the effluent flow of the heat exhaustive through it, condensation will often form on the interior of the pipes and the joints of the sections of pipe can leak water and cause damage to the interior of the structure.

### SUMMARY

One aspect provides a vent pipe section that comprises a body member having first and second ends and a central axis along a length thereof. A latch receiving member protrudes from a side surface of and is coupled to the body member and located adjacent one of the first or second ends. A movable latch is attached to the body member and located adjacent an end opposite to that of the latch receiving member and is configured to cooperatively engage the latch receiving member and exert a locking force along the central axis of the body member. This embodiment further includes a stop located on an outer surface of the body member adjacent the second end.

Another embodiment provides a method of fabricating the vent pipe. One method embodiment may comprise forming a body member having first and second ends and a central axis along a length thereof, placing a latch receiving member on the body member adjacent of the first or second sends such that the latch receiving member protrudes outwardly from a side surface of the body member, securing a movable latch to the body member adjacent an end opposite to that of the latch receiving member that is configured to cooperatively engage the latch receiving member and exert a locking force along the central axis of the body member, and forming a stop on an outer surface of the body member adjacent the second end.

In another embodiment, a vent pipe system is provided. This embodiment comprises a first body member having first and second ends and a central axis along a length thereof, a second body member having first and second ends and a central axis along a length thereof, a latch receiving member protruding from a side surface of and coupled to the first body member adjacent the first end of the first body member, a movable latch attached to and adjacent the second end of the second body member and configured to cooperatively engage the latch receiving member and exert a locking force along the central axes of the first and second body members, and a stop located on an outer surface of and adjacent the second end of the second body member.

### BRIEF DESCRIPTION

Reference is now made to the following descriptions taken in conjunction with the accompanying drawings, in which:

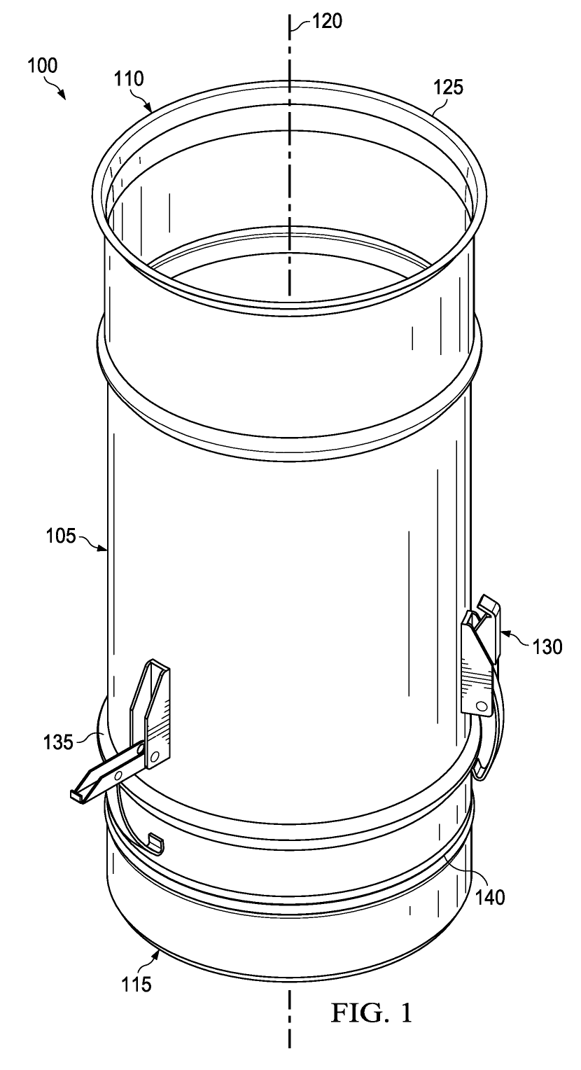

FIG. 1 illustrate an embodiment of a vent pipe as provided by this disclosure;

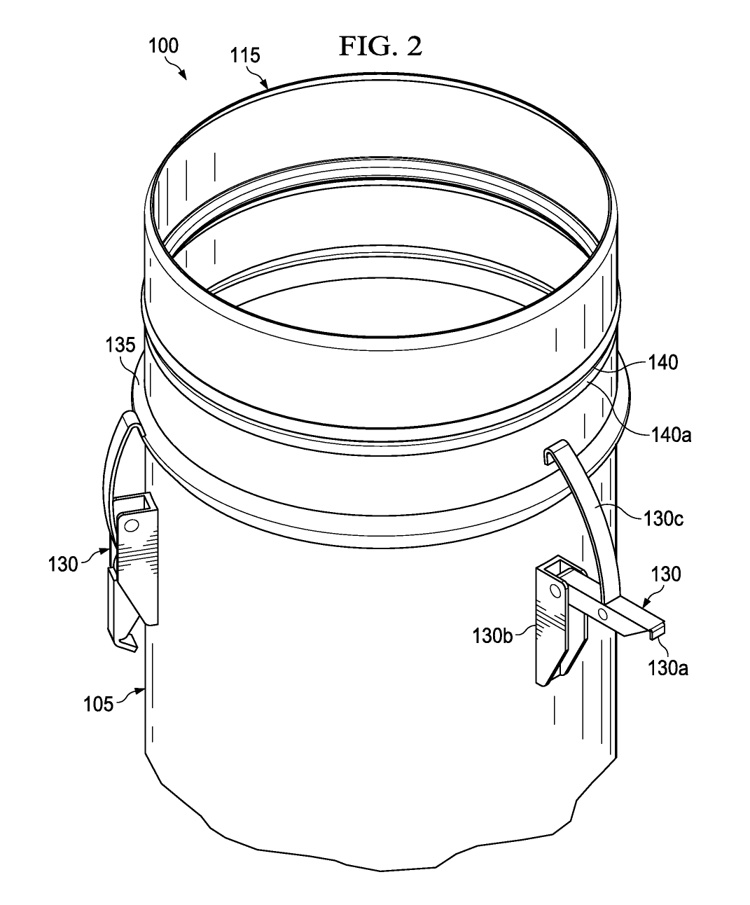

FIG. 2 illustrates one end of the embodiment of FIG. 1;

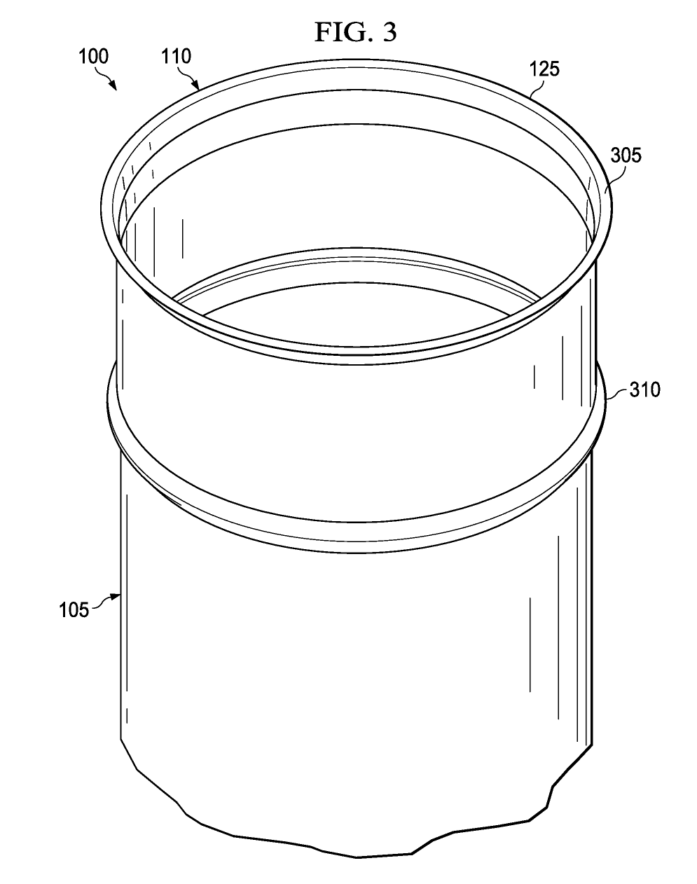

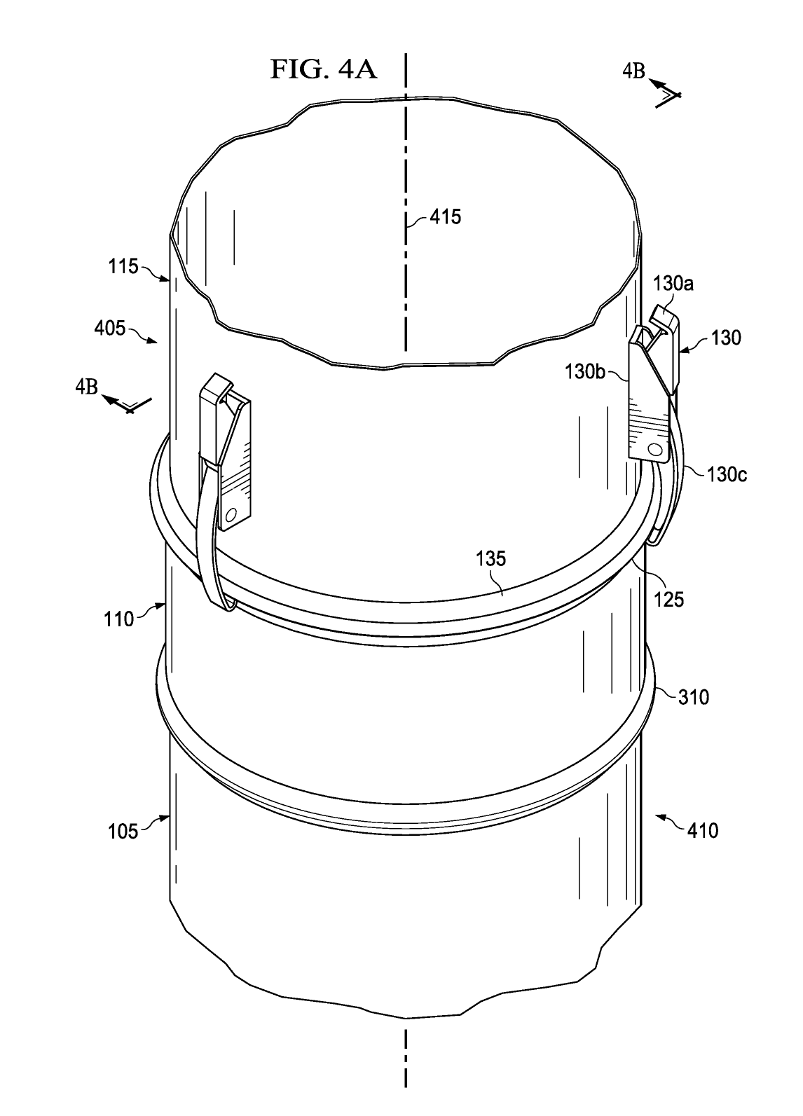

FIG. 3 illustrates an opposite end of the embodiment of FIG. 1;

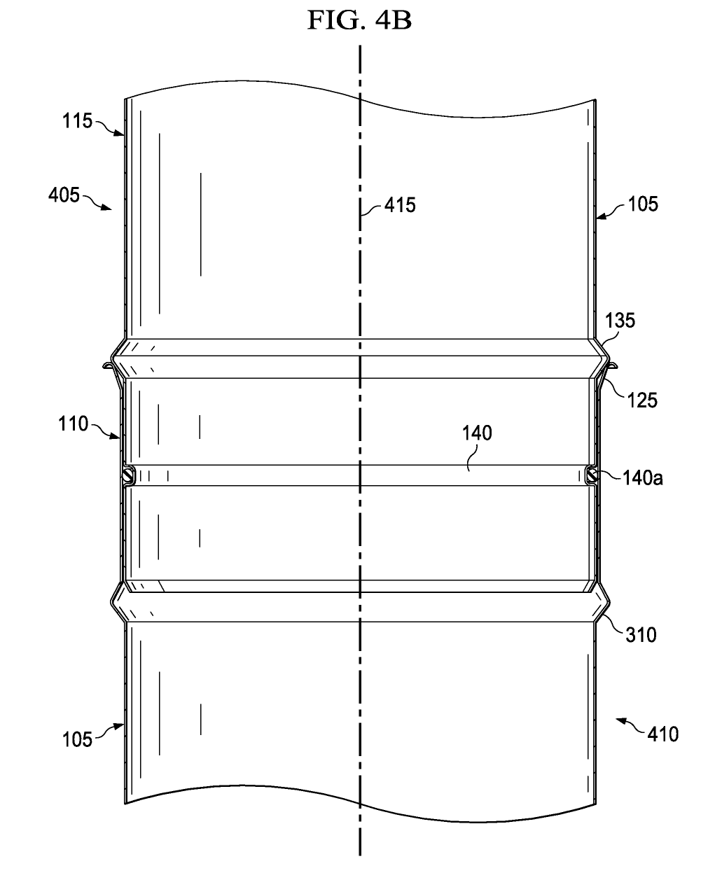

FIG. 4A illustrates a partial view of two vent pipes of FIG. 1 that have been coupled together as provided in this disclosure;

FIG. 4B illustrates a sectional view of FIG. 4A showing how the sealing ring seals against the inner wall of an adjoining vent pipe;

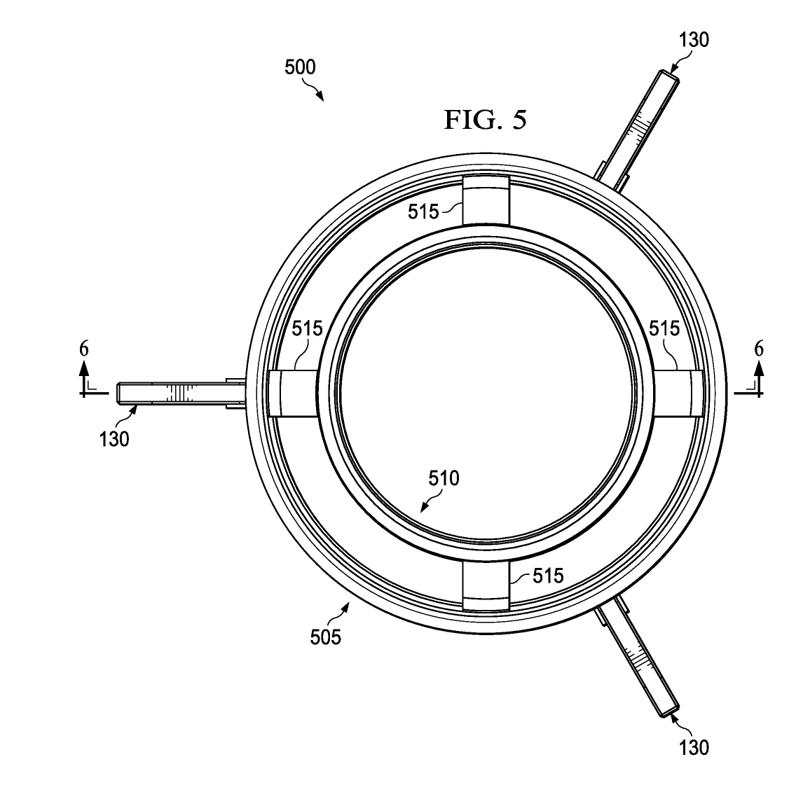

FIG. 5 illustrates an embodiment of concentric vent pipes as provided herein; and

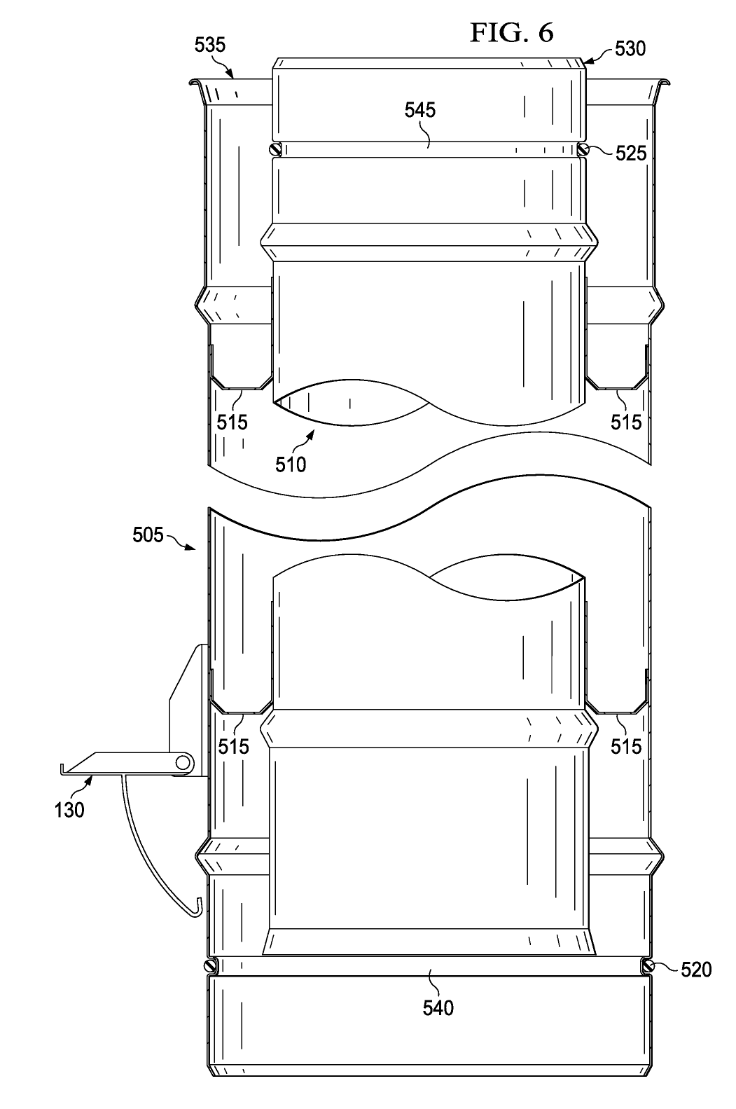

FIG. 6 illustrates a sectional view of the embodiment of FIG. 5.

### DETAILED DESCRIPTION

FIG. 1 illustrates an embodiment of a vent pipe section 100 as covered by this disclosure. As seen in this illustrated embodiment, the vent pipe section 100 comprises a body member 105 having first and second ends 110, 115 and a central axis 120 along a length thereof. The body member may be constructed of conventional materials, such as stainless steel, tin, aluminum, or high temperature thermo plastics. It should be noted that even though the illustrated embodiment shows the first end 110 configured as a female end and the second end 115 configured as a male end, this configuration may be switched or they either both be male ends or female ends in other embodiments. A latch receiving member 125 protrudes from a side surface of and is coupled to the body member 105 and is located adjacent one of the first or second ends 110, 115. A movable latch 130 is attached to the body member 105 and is located adjacent an end opposite to that of the latch receiving member 125 and is configured to cooperatively engage the latch receiving member 125 and exert a locking force along the central axis of the body member 105, which improves the structural integrity of joined vent pipes over those of conventional design. A vent pipe stop 135 is located on an outer surface of the body member 105 and adjacent the second end 115. In another embodiment, the vent pipe 100 may further include a sealing ring groove 140 located in the outer surface of the body member 105 between the second end 115 and the stop 135. The sealing ring groove 140 extends around a perimeter of the body member 105 and is configured to receive a sealing ring 140a therein. When present, the sealing ring provides the added benefit of reducing condensate or water leakage between adjoining vent pipes.

In one embodiment, the vent pipe 100 may be manufactured by using conventional fabrication processes to form the body member 105. In one aspect thereof, the body member 105 may be formed from a heavier gauge sheet metal, such as stainless steel, that may range from about 30 gauge to about 20 gauge. Conventional process may also be used to fabricate or couple the latch receiving member 125 to the outer surface of the body member 105. As mentioned above, the receiving member 125 may be molded as an outwardly curved lip on the end of the first end 110 of the body member 105, or it may be a separate structure that is secured to the outer surface of the body member 105. Conventional process, such as riveting, welding or bolting, may be used to secure the movable latch 130 to the body member 105. Conventional sheet metal fabrication processes may also be used to form the stop 130 on the outer surface of the body member adjacent the second end 115. Alternatively, the stop 130 may be a separate structure that can be secured using conventional processes.

FIG. 2 illustrates a partial view of an embodiment of the second end 115 of the vent pipe section 100. As seen here, the second end 115 may include two movable latches 130. In one embodiment, they may be positioned an equal distance about the perimeter of the body member 105 and located on opposite sides thereof. In yet another embodiment, the second end 115 may include three movable latches 130. For example, three movable latches 130 may be present and spaced an equal distance apart around the perimeter of the body member 105, or in yet another configuration, the second end 115 may have four or more latches 130 spaced equally apart about the perimeter of the body member 105.

The movable latches 130, as shown in the illustrated embodiment, are levered latches and in one aspect thereof, they may comprise a lever arm 130a that is rotatably coupled to a base member 130b that is secured to the body member 105, and a flexible latching arm 130c that is rotatably coupled to the lever arm 130a. In one embodiment, the flexible latching arm 130c may have a spring-like bias associated with it that allows the lever arm 130a to remain in a clamped and latched position. It should be understood that other movable latches known to those skilled in the art, other than the one specifically illustrated herein and capable of exerting a locking force along the central axis of the body member 105, may also be used.

The movable latch 130 provides a beneficial feature and improvement over conventional designs in that the primary locking force runs in the same direction as the central axis of the body member 105, thereby providing additional structural support when two or more vent pipes are joined together to span a given distance.

As seen in the illustrated embodiment of FIG. 2, the second end 115 is configured as a male end; that is, a section of the end has an external diameter that allows it to be inserted into a female end having a larger internal diameter of another section of vent pipe. As shown below in FIG. 4B, the stop 135 is positioned adjacent the second end 115 to allow proper seating in a corresponding end of another vent pipe. In the illustrated embodiment, the stop 135 is a rim that is molded from the body member 105, but in other embodiments it may be a separate structure attached to the outer surface of the body member 105.

FIG. 3 illustrates a partial view of the first end 110, as seen in FIG. 1. As mentioned above, the first end 110 includes a latch receiving member 125. In the illustrated embodiment, the latch receiving member 125 comprises an outwardly curled edge 305 with which the latching arm 130c of the movable latch 130 (FIG. 2) can cooperatively engage. However, in other embodiments, the latch receiving member 130 may be some other type of protrusion that is attached to or formed from the body member 105. For example, the latch receiving member 130 may be configured as a hook that is separately attached to the body member 105 or a ledge that is formed from the body member 105. The first end 110 may also include a reinforcing rib 310 that adds structural strength to the vent pipe 100. The reinforcing rib 310 may be formed from the body member 105 as seen in FIG. 3, or in other embodiments, it may be a separate structure that is attached to the body member 105.

FIG. 4A illustrates an embodiment where two vent pipes 405 and 410 are coupled together at their first and second respective ends 110 and 115. As seen here, the movable latches 130 are shown in the locked position wherein the flexible latching arm 130c is engaged with the latching receiving member 125. Unlike conventional systems typically associated with vent pipes, the movable latches 130, as disclosed herein, provide a locking force that is in the direction as the central axis 415 of the vent pipes 405 and 410.

FIG. 4B is a sectional view of FIG. 4A taken along the line 4B-4B that illustrates the positions of the ends 110 and 115 of the vent pipes 405, 410 relative to one another when joined together. As seen in this embodiment, the second end 115 of the vent pipe 405 is received within the first end 110 of vent pipe 410. The stop 135 is engaged against the inner diameter of the end of vent pipe 410, as shown. The sealing ring 140a seals against the inner diameter of vent pipe 410 and prevents water from leaking between the joined vent pipes.

FIG. 5 illustrates another embodiment of a vent pipe 500. This embodiment includes concentric vent pipes 505 and 510. Vent pipes 505, 510 may be configured as the embodiments previously discussed regarding the FIGS. 1 through 4B. However, in certain embodiments, the movable latch 130 may not be present in vent pipe's 510 configuration. In certain embodiments, the concentric vent pipes 505, 510 may be kept in concentric alignment relative to one another by one or more off-set braces or brackets 515. The concentric vent pipe configuration is useful in those situations where regulations or engineering specifications require double vent pipe applications.

FIG. 6 is a sectional view of FIG. 5 taken along line 6-6. The orientation of vent pipe 505 to 510 may vary. For example, vent pipe 510 may have a reversed orientation to that of vent pipe 505, that is, the male end 530 of vent pipe 510 may be located near the female 535 end of vent pipe 510. Alternatively, the ends of vent pipe 505 and 510 may be oriented the same, that is, the male end of vent pipe 510 may be located near a male end of vent pipe 505. In the illustrated embodiment of FIG. 6, both vent pipe 505 and 510 include a sealing ring 520, 525, located in their respective sealing ring grooves 540, 545.

The embodiments as described herein provide an improved vent pipe configuration that improves structural strength support by way of the movable latch that exerts a locking force along the central axis of the vent pipe's body member and in other embodiments reduces water or condensate leakage between adjoining vent pipes.

Those skilled in the art to which this application relates will appreciate that other and further additions, deletions, substitutions and modifications may be made to the described embodiments.

What is claimed is:

1. A vent pipe section, comprising:
a body member having first and second ends and a central axis along a length thereof;
a latch receiving member protruding from a side surface of and coupled to said body member and located adjacent one of said first or second ends;
a movable latch attached to said body member and located adjacent an end opposite to that of said latch receiving member and configured to cooperatively engage said latch receiving member and exert a locking force along said central axis of said body member; and
a stop located on an outer surface of said body member adjacent said second end.

2. The vent pipe of claim 1, further including a sealing ring groove located in said outer surface of said body member between said second end and said stop, said sealing ring groove extending around a perimeter of said body member, and a sealing ring positioned in said sealing ring groove.

3. The vent pipe of claim 1, wherein said latch receiving member is an outwardly curved edge of said first end that extends around said first end.

4. The vent pipe of claim 1, wherein said movable latch is a levered latch.

5. The vent pipe of claim 4, wherein said levered latch comprises a lever arm that is rotatably coupled to a base member that is secured to said body member, and a latching arm that is rotatably coupled to said lever arm.

6. The vent pipe of claim 1, wherein said first end is configured as a female connector end and said second end is configured as a male connector end.

7. The vent pipe of claim 1, wherein said movable latch is a first movable latch and wherein said vent pipe section further includes second and third movable latches coupled to said body member, said first, second, and third movable latches being positioned an equal distance about an outer surface of said body member.

8. The vent pipe of claim 1, wherein said body member is a first body member and the vent pipe further comprises a second body member having a central axis and located within and concentric to said first body member.

9. The vent pipe of claim 8, wherein said second body member comprises:
a second stop located on an outer surface of said second body member adjacent said second end of said second body member;
a second sealing ring groove located in said outer surface of said second body member between said second end and said second stop of said second body member, said second sealing ring groove extending around a perimeter of said second body member and configured to receive a sealing ring therein; and
a second sealing ring positioned within said second sealing ring groove.

10. A method of manufacturing a vent pipe, comprising:
forming a body member having first and second ends and a central axis along a length thereof;
placing a latch receiving member on said body member adjacent of said first or second sends such that said latch receiving member protrudes outwardly from a side surface of said body member;
securing a movable latch to said body member adjacent an end opposite to that of said latch receiving member and configured to cooperatively engage said latch receiving member and exert a locking force along said central axis of said body member; and
forming a stop on an outer surface of said body member adjacent said second end.

11. The method of claim 10, further including forming a sealing ring groove in said outer surface of said body member adjacent between said second end and said stop, said sealing ring groove extending around a perimeter of said body member, and placing a sealing ring within said sealing ring groove.

12. The method of claim 10, wherein placing said latch receiving member comprises forming an outwardly curved edge from said first end that and extends around said first end.

13. The method of claim 10, wherein said movable latch is a levered latch.

14. The method of claim 13, wherein said levered latch comprises a lever arm and a latching arm that is rotatably coupled to said lever arm.

15. The method of claim 10, wherein forming a body member comprises configuring said first end as a female connector end and configuring said second end as a male connector end.

16. The method of claim 10, wherein said movable latch is a first movable latch and said method further includes securing second and third movable latches about said body member, said first, second and third movable latched being positioned equal distance about an outer surface of said body member.

17. A vent pipe system, comprising:
a first body member having first and second ends and a central axis along a length thereof;
a second body member having first and second ends and a central axis along a length thereof;
a latch receiving member protruding from a side surface of and coupled to said first body member adjacent said first end of said first body member;
a movable latch attached to and adjacent said second end of said second body member and configured to cooperatively engage said latch receiving member and exert a locking force along said central axes of said first and second body members;
a stop located on an outer surface of and adjacent said second end of said second body member.

18. The vent pipe system of claim 17, further including a sealing ring groove located in said outer surface of said second body member between said second end of said second body member and said stop, said sealing ring groove extending around a perimeter of said second body member, and a sealing ring positioned in said sealing ring groove.

19. The vent pipe system of claim 17, wherein said latch receiving member is an outwardly curved edge of said first body member that extends around said first end.

20. The vent pipe system of claim 17, wherein said movable latch is a levered latch.

21. The vent pipe system of claim 20, wherein said levered latch comprises a lever arm and a latching arm that is rotatably coupled to said lever arm.

22. The vent pipe system of claim 17, wherein said first end of said first body member is configured as a female connector end and said second end of said second body member is configured as a male connector end.

23. The vent pipe system of claim 17, wherein said movable latch is a first movable latch and wherein said second body member further includes second and third movable latches coupled to said second body member, said first, second and third movable latched being positioned equal distance about an outer surface of said second body member.

24. The vent pipe system of claim 17, wherein said first and second body members further comprise a third and fourth body members each having first and second ends and a central axis and located within and concentric to said first and second body members, respectively.

25. The vent pipe of claim 24, wherein said third body member comprises a stop located on an outer surface of said third body member adjacent said second end of said third body member;
a second sealing ring groove located in said outer surface of said second body member between said second end and said second stop of said second body member, said second sealing ring groove extending around a perimeter of said second body member and configured to receive a sealing ring therein; and
a second sealing ring positioned within said second sealing ring groove.
